(19) United States
(12) Patent Application Publication
(10) Pub. No.: US 2011/0163917 A1
(43) Pub. Date: Jul. 7, 2011

(54) METHOD AND SYSTEM FOR ANTENNA ORIENTATION COMPENSATION FOR POWER RANGING

(76) Inventors: David Lundgren, Mill Valley, CA (US); James LaMance, Hixson, TN (US)

(21) Appl. No.: 12/652,157

(22) Filed: Jan. 5, 2010

(51) Int. Cl. G01S 3/02

(52) U.S. Cl. 342/463

(57) ABSTRACT

A mobile device comprising an antenna may be operable to adjust a plurality of received signal strength indications (RSSIs) for a plurality of known RF nodes based on an orientation of the antenna and an antenna gain profile (AGP) of the antenna. The mobile device may be operable to calculate a position of the mobile device utilizing a power ranging based on the adjusted plurality of RSSIs. The mobile device may generate an antenna orientation report (AOR) utilizing a magnetometer and an accelerometer in the mobile device and determine the orientation of the antenna based on the AOR. The mobile device may be operable to determine an antenna gain value associated with each of the plurality of RSSIs for the plurality of known RF nodes based on the orientation of the antenna and the AGP of the antenna.

### CROSS-REFERENCE TO RELATED APPLICATIONS/INCORPORATION BY REFERENCE

Not applicable

### FIELD OF THE INVENTION

Certain embodiments of the invention relate to communication systems. More specifically, certain embodiments of the invention relate to a method and system for antenna orientation compensation for power ranging.

### BACKGROUND OF THE INVENTION

Location based services (LBS) are emerging as a new type of value-added service provided by mobile or wireless communication network service providers. LBS are mobile services in which the location information of mobile devices is used in order to enable various LBS applications such as, for example, enhanced 911 (E-911), location-based 411, location-based messaging and/or local restaurants finding. A position of a mobile device may be determined in different ways such as, for example, using a network-based technology, using a terminal-based technology, and/or a hybrid technology (a combination of the former technologies).

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for antenna orientation compensation for power ranging, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating an exemplary communication system that is operable to provide antenna orientation compensation for power ranging, in accordance with an embodiment of the invention.

FIG. 2 is a block diagram illustrating an exemplary mobile device that is operable to provide antenna orientation compensation for power ranging, in accordance with an embodiment of the invention.

FIG. 3 is a block diagram illustrating an exemplary antenna orientation of a mobile device, in accordance with an embodiment of the invention.

FIG. 4 is a flow chart illustrating exemplary steps for generating an antenna gain profile, in accordance with an embodiment of the invention.

FIG. 5 is a flow chart illustrating exemplary steps for antenna orientation compensation for power ranging, in accordance with an embodiment of the invention.

### DETAILED DESCRIPTION OF THE INVENTION

Certain embodiments of the invention can be found in a method and system for antenna orientation compensation for power ranging. In various embodiments of the invention, a mobile device comprising an antenna may be operable to adjust a plurality of received signal strength indications (RSSIs) for a plurality of known RF nodes based on an orientation of the antenna and an antenna gain profile (AGP) of the antenna. The mobile device may be operable to calculate a position of the mobile device utilizing a power ranging based on the adjusted plurality of RSSIs. In this regard, the mobile device may be operable to acquire a reference position of the mobile device and calculate the position of the mobile device by iterating a non-linear estimation based on the reference position of the mobile device and the adjusted plurality of RSSIs. The mobile device may be operable to generate an antenna orientation report (AOR) utilizing a magnetometer in the mobile device, an accelerometer in the mobile device and a declination at the reference position. The mobile device may be operable to determine the orientation of the antenna based on the antenna orientation report. The mobile device may be operable to determine an antenna gain value associated with each of the plurality of RSSIs for the plurality of known RF nodes based on the orientation of the antenna, the AGP of the antenna, positions of the known RF nodes and the reference position of the mobile device. In instances where the antenna gain value associated with a RSSI indicates a signal loss, the mobile device may be operable to increase the value of the RSSI according to the antenna gain value. In instances where the antenna gain value associated with a RSSI indicates a signal gain, the mobile device may be operable to decrease the value of the RSSI according to the antenna gain value. The mobile device may be operable to acquire the AGP of the antenna from either a location server or from information stored in the mobile device.

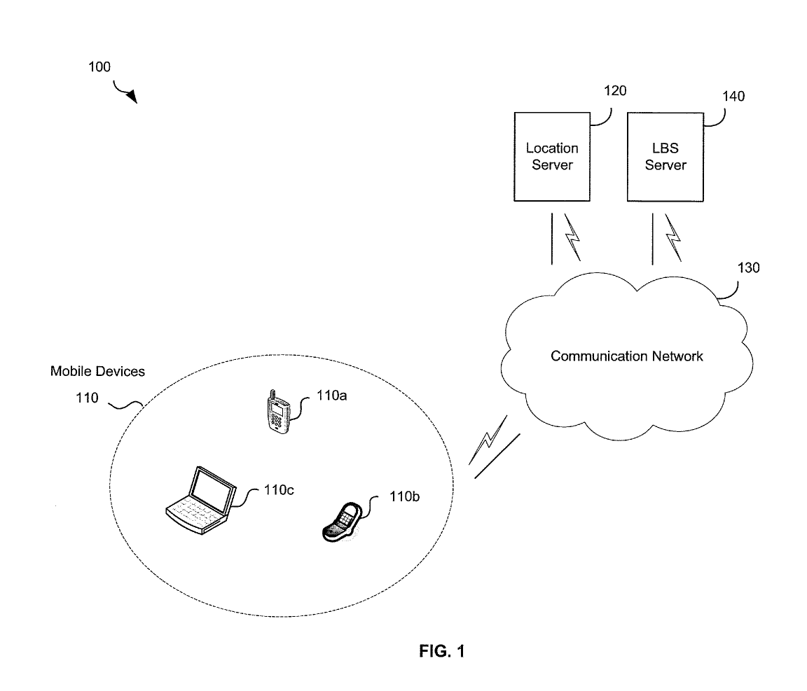

FIG. 1 is a block diagram illustrating an exemplary communication system that is operable to provide antenna orientation compensation for power ranging, in accordance with an embodiment of the invention. Referring to FIG. 1, there is shown a communication system 100. The communication system comprises a plurality of mobile devices 110, of which mobile devices 110a-110c are illustrated, a location server 120, a communication network 130 and a LBS Server 140.

A mobile device such as the mobile device 110a may comprise suitable logic, circuitry, interfaces and/or code that are operable to communicate radio signals across the communication network 130. The mobile device 110a may be operable to acquire a reference position or location for the purpose of location based services such as, for example, enhanced 911, location-based 411, location-based messaging and/or local restaurants finding. The reference position may be, for example, obtained from the location server 120 or estimated from known RF node positions.

A power ranging such as, for example, a network measurement report/measured results list (NMR/MRL) positioning technique uses the total path loss of a signal received to determine a range or distance between the transmitter such as the RF node and the mobile device or mobile receiver. The farther the mobile device or mobile receiver is from the known transmitter such as the RF node, the higher the path loss. Once the path loss model is determined, a variety of algorithms can be used to calculate the range for the given path loss accounting for variables such as frequency, height of the transmitter, height of the mobile receiver, local topography, and other such effects.

The accuracy of the location of the mobile device 110a using a power ranging method may depend on the orientation of an antenna of the mobile device 110a and the variation of the antenna gain with direction relative to the mobile device 110a. The location of the mobile device 110a may appear incorrectly further from transmitters or RF nodes such as, for example, cell stations, WiFi access points or FM stations in instances where the RF nodes are aligned with weak antenna gain directions, and artificially closer in instances where the RF nodes are aligned with strong antenna gain directions.

A received signal strength indication (RSSI) is a measurement of the power or signal strength presented in the received radio signal at the antenna of the mobile device 110a from a RF node. The RSSI may be obtained from, for example, a NMR or MRL. An effective radiated power (ERP) of a RF node is a measurement of transmitted radio signal strength from the RF node. The power ranging method uses the RSSI at the antenna of the mobile device 110a to establish range (distance) of the mobile device 110a relative to a plurality of RF nodes of known position and ERP. The farther the mobile device 110a is from the known RF nodes, the lower the RSSI. The plurality of RF nodes may comprise, for example, a serving cell station of the mobile device 110a and neighboring cell stations.

An antenna gain profile (AGP) is a 3-dimension (3D) antenna gain pattern information of a device model relative to an antenna centered device fixed (ACDF) coordinate system. The AGP may be generated from calibration done on a representative device unit in a test chamber. The AGP for a number of possible device models may be stored in, for example, the location server 120 and/or a database in the mobile device 110a.

An antenna orientation report (AOR) is a 3D antenna orientation data relative to an antenna centered device fixed (ACDF) coordinate system. The RF node positions are known in a north east down (NED) coordinate system or an east north up (ENU) coordinate system. Sensors in the mobile device 110a such as a magnetometer and/or an accelerometer may be used to determine a physical antenna orientation in the NED or the ENU coordinate system. Once the rotation from the ACDF system to the NED or the ENU system is known, the AOR may be rotated to the NED or the ENU system and may be defined in terms of azimuth (relative to magnetic north) and elevation (relative to gravitational field). The azimuth may be determined utilizing, for example, the magnetometer in the mobile device 110a. The elevation may be determined utilizing, for example, the accelerometer in the mobile device 110a. A declination (magnetic declination) may be adjusted for the azimuth by, for example, the reference position of the mobile device 110a. The orientation of the antenna in the mobile device 110a may be determined based on the AOR.

The mobile device 110a comprising an antenna may be operable to adjust a plurality of RSSIs for a plurality of known RF nodes based on an orientation of the antenna and an AGP of the antenna. The mobile device 110a may be operable to calculate a position of the mobile device 110a utilizing a power ranging based on the adjusted plurality of RSSIs. The mobile device 110a may be operable to calculate the position of the mobile device 110a by iterating a non-linear estimation based on the reference position of the mobile device 110a and the adjusted plurality of RSSIs. The mobile device 110a may be operable to generate an AOR utilizing, for example, a magnetometer in the mobile device 110a, an accelerometer in the mobile device 110a and a declination at the reference position. The mobile device 110a may be operable to determine the orientation of the antenna based on the AOR. The mobile device 110a may be operable to determine an antenna gain value associated with each of the plurality of RSSIs for the plurality of known RF nodes based on the orientation of the antenna, the AGP of the antenna, positions of the known RF nodes and the reference position of the mobile device 110a. In instances where the antenna gain value associated with a RSSI indicates a signal loss, the mobile device 110a may be operable to increase the value of the RSSI according to the antenna gain value or otherwise provide compensation for the signal loss. In instances where the antenna gain value associated with a RSSI indicates a signal gain, the mobile device 110a may be operable to decrease the value of the RSSI according to the antenna gain value, or otherwise provide compensation for the signal gain. The mobile device 110a may be operable to acquire the AGP of the antenna from either a location server 102 or from information stored in the mobile device 110a.

The location server 120 may comprise suitable logic, circuitry, interfaces and/or code that may be operable to identify and provide various positions or locations associated with communication devices such as the mobile device 110a for the purpose of location based services such as, for example, enhanced 911, location-based 411, location-based messaging and/or local restaurants finding. The location server 120 may be operable to translate the position or location information into latitude/longitude (LAT/LON) associated with the location of the mobile device 110a. The location server 120 may be operable to provide a reference position or initial position of the mobile device 110a.

The communication network 130 may comprise suitable logic, circuitry, interfaces and/or code that may be operable to provide voice and data services to various mobile devices such as the mobile devices 110a-110c by using wireless and/or wired communication technologies such as, for example, WCDMA, UMTS, HSDPA, CDMA, EV-DO, GSM, GPRS, EDGE, EGPRS, LTE, Bluetooth, WiMAX, WiFi, FM, mobile TV and Ethernet. The communication network 130 may be operable to provide communication among the location server 120, the LBS server 140 and a plurality of served mobile devices such as the mobile device 110a.

The LBS server 140 may comprise suitable logic, circuitry, interfaces and/or code that may be operable to retrieve information such as, for example, local hotel addresses or a map of the vicinity of areas of interest. The LBS server 140 may be operable to communicate the retrieved information with various communication devices such as the mobile device 110a based on an associated position.

In operation, the mobile device 110a comprising an antenna may be operable to adjust a plurality of RSSIs for a plurality of known RF nodes based on an orientation of the antenna and an AGP of the antenna. The mobile device 110a may be operable to calculate a position of the mobile device 110a utilizing a power ranging based on the adjusted plurality of RSSIs. The mobile device 110a may be operable to acquire a reference position. The reference position may be, for example, obtained from the location server 120 or estimated from known RF node positions. The mobile device 110a may be operable to calculate the position of the mobile device 110a by iterating a non-linear estimation based on the reference position of the mobile device 110a and the adjusted plurality of RSSIs. The mobile device 110a may be operable to generate an AOR utilizing a magnetometer in the mobile device 110a, an accelerometer in the mobile device 110a and a declination at the reference position. The mobile device 110a may be operable to determine the orientation of the antenna based on the AOR. The mobile device 110a may be operable to determine an antenna gain value associated with each of the plurality of RSSIs for the plurality of known RF nodes based on the orientation of the antenna, the AGP of the antenna, positions of the known RF nodes and the reference position of the mobile device 110a. In instances where the antenna gain value associated with a RSSI indicates a signal loss, the mobile device 110a may be operable to increase the value of the RSSI according to the antenna gain value. In instances where the antenna gain value associated with a RSSI indicates a signal gain, the mobile device 110a may be operable to decrease the value of the RSSI according to the antenna gain value. The mobile device 110a may be operable to acquire the AGP of the antenna from either a location server 120 or from information stored in the mobile device 110a.

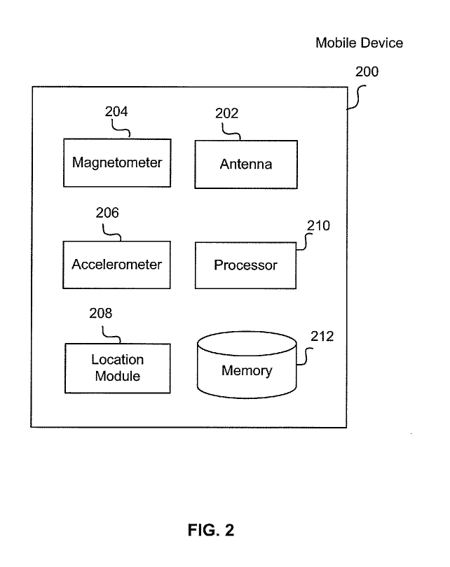

FIG. 2 is a block diagram illustrating an exemplary mobile device that is operable to provide antenna orientation compensation for power ranging, in accordance with an embodiment of the invention. Referring to FIG. 2, there is shown a mobile device 200. The mobile device 200 may comprise an antenna 202, a magnetometer 204, an accelerometer 206, a location module 208, a processor 210 and a memory 212.

The antenna 202 may comprise suitable logic, circuitry, interfaces and/or code that may be operable to communicate radio signals over the communication network 130.

The magnetometer 204 may comprise suitable logic, circuitry, interfaces and/or code that may be operable to sense a yaw of the antenna orientation (in degrees) relative to the magnetic north. The accelerometer 206 may comprise suitable logic, circuitry, interfaces and/or code that may be operable to sense a roll and a pitch of the antenna orientation (in degrees) relative to the gravitational field. The yaw, the roll and/or the pitch may be combined to define an azimuth of the antenna orientation (in degrees) relative to the magnetic north and an elevation or tilt of the antenna orientation (in degrees) relative to the gravitational field. The azimuth and the elevation of the antenna orientation may be made available in the format of the AOR.

The location module 208 may comprise suitable logic, circuitry, interfaces and/or code that may be operable to calculate a position of the mobile device 200 utilizing a power ranging method such as, for example, a NMR/MRL positioning technique. The location module 208 may be operable to adjust a plurality of RSSIs for a plurality of known RF nodes based on an orientation of the antenna 202 and an AGP of the antenna 202. The location module 208 may be operable to calculate a position of the mobile device 200 utilizing a power ranging based on the adjusted plurality of RSSIs. The location module 208 may be operable to acquire a reference position. The reference position may be, for example, obtained from the location server 120 or estimated from known RF node positions.

The location module 208 may be operable to calculate the position of the mobile device 200 by iterating a non-linear estimation based on the reference position of the mobile device 200 and the adjusted plurality of RSSIs. The location module 208 may be operable to generate an AOR utilizing the magnetometer 204, the accelerometer 206 and a declination at the reference position. The location module 208 may be operable to determine the orientation of the antenna 202 based on the AOR. The location module 208 may be operable to determine an antenna gain value associated with each of the plurality of RSSIs for the plurality of known RF nodes based on the orientation of the antenna 202, the AGP of the antenna 202, positions of the known RF nodes and the reference position of the mobile device 200. In instances where the antenna gain value associated with a RSSI indicates a signal loss, the location module 208 may be operable to increase the value of the RSSI according to the antenna gain value. In instances where the antenna gain value associated with a RSSI indicates a signal gain, the location module 208 may be operable to decrease the value of the RSSI according to the antenna gain value. The location module 208 may be operable to acquire the AGP of the antenna 202 from either a location server 102 or from information stored in the memory 212.

The processor 210 may comprise suitable logic, circuitry, interfaces and/or code that may be operable to process signals from the antenna 202 and the location module 208. The processor 210 may be operable to communicate signals with the communication network 130 via the antenna 202. The processor 210 may be operable to communicate location information with the communication network 130 for various location based services such as E-911, location-based 411 and/or location-based messaging.

The memory 212 may comprise suitable logic, circuitry, and/or code that operable to store information such as executable instructions, data and/or database that may be utilized by the processor 210 and the location module 208. The memory 212 may comprise RAM, ROM, low latency nonvolatile memory such as flash memory and/or other suitable electronic data storage.

In operation, the location module 208 may be operable to adjust a plurality of RSSIs for a plurality of known RF nodes based on an orientation of the antenna 202 and an AGP of the antenna 202. The location module 208 may be operable to calculate a position of the mobile device 200 utilizing a power ranging based on the adjusted plurality of RSSIs. The location module 208 may be operable to acquire a reference position. The location module 208 may be operable to calculate the position of the mobile device 200 by iterating a non-linear estimation based on the reference position of the mobile device 200 and the adjusted plurality of RSSIs. The location module 208 may be operable to generate an AOR utilizing the magnetometer 204, the accelerometer 206 and a declination at the reference position. The location module 208 may be operable to determine the orientation of the antenna 202 based on the AOR. The location module 208 may be operable to determine an antenna gain value associated with each of the plurality of RSSIs for the plurality of known RF nodes based on the orientation of the antenna 202, the AGP of the antenna 202, positions of the known RF nodes and the reference position of the mobile device 200. In instances where the antenna gain value associated with a RSSI indicates a signal loss, the location module 208 may be operable to increase the value of the RSSI according to the antenna gain value. In instances where the antenna gain value associated with a RSSI indicates a signal gain, the location module 208 may be operable to decrease the value of the RSSI according to the antenna gain value. The location module 208 may be operable to acquire the AGP of the antenna 202 from either a location server 102 or from information stored in the memory 212.

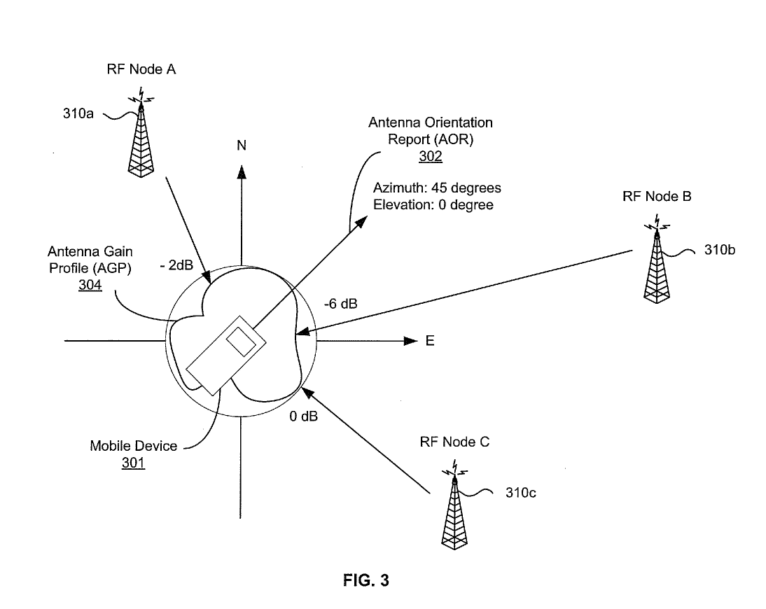

FIG. 3 is a block diagram illustrating an exemplary antenna orientation of a mobile device, in accordance with an embodiment of the invention. Referring to FIG. 3, there is shown a mobile device 301, an antenna orientation report (AOR) 302, an antenna gain profile (AGP) 304, and a plurality of known RF nodes, for example, RF node A 310a, RF node B 310b and RF node C 310c.

The antenna orientation report (AOR) 302 indicates that the orientation of the mobile device 301 is at, for example, 45 degrees azimuth and 0 degree elevation. Based on the antenna orientation report (AOR) 302, the positions of the RF node A 310a, the RF node B 310b and the RF node C 310c, and the reference position of the mobile device 301, the antenna gain profile (AGP) 304 indicates that the antenna gain value associated with the RSSI for the RF node A 310a is, for example, −2 dB, the antenna gain value associated with the RSSI for the RF node B 310b is, for example, −6 dB, and the antenna gain value associated with the RSSI for the RF node C 310c is, for example, 0 dB.

In an exemplary embodiment of the invention, the mobile device 301 may be operable to increase the value of the RSSI for the RF node A 310a according to the 2 dB signal loss, increase the value of the RSSI for the RF node B 310b according to the 6 dB signal loss and introduce no adjustment to the value of the RSSI for the RF node C 310c according to the 0 dB antenna gain value. The mobile device 301 may be operable to calculate a position of the mobile device 301 utilizing a power ranging such as iterating a non-linear estimation based on the reference position of the mobile device 301 and the adjusted RSSI values for the RF node A 310a, the RF node B 310b and the RF node C 310c.

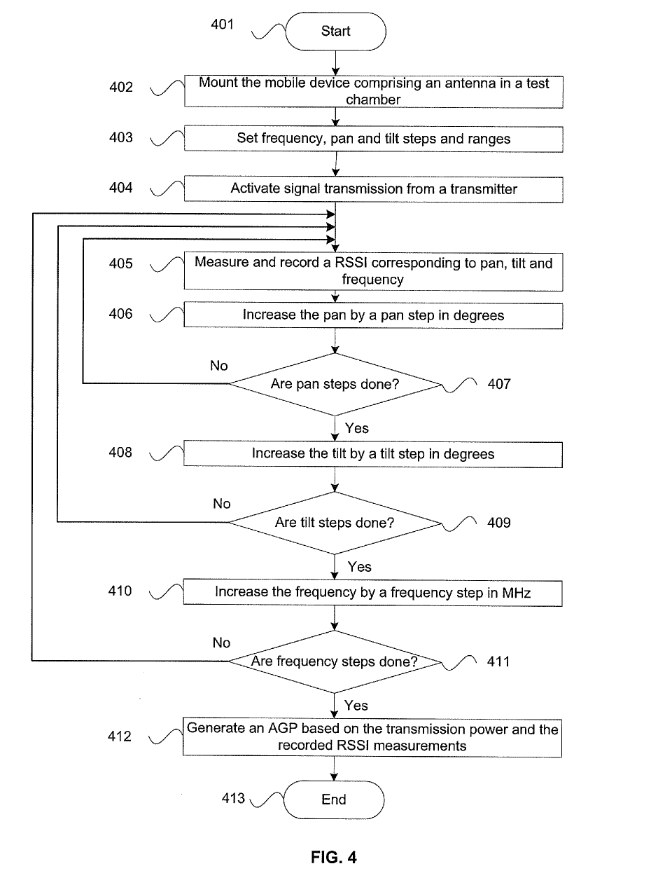

FIG. 4 is a flow chart illustrating exemplary steps for generating an antenna gain profile, in accordance with an embodiment of the invention. Referring to FIG. 4, the exemplary steps start at step 401. In step 402, the mobile device 200 comprising an antenna 202 is mounted in a test chamber. In step 403, frequency, pan and tilt steps and ranges are set. In step 404, signal transmission from a transmitter is activated. In step 405, a RSSI is measured and recorded corresponding to pan, tilt and frequency. In step 406, the pan is increased by a pan step in degrees. In step 407, the completion of pan steps is checked. In instances when the pan steps are done, the exemplary steps may proceed to step 408. In step 408, the tilt is increased by a tilt step in degrees. In step 409, the completion of tilt steps is checked. In instances when the tilt steps are done, the exemplary steps may proceed to step 410. In step 410, the frequency is increased by a frequency step in MHz. In step 411, the completion of frequency steps is checked. In instances when the frequency steps are done, the exemplary steps may proceed to step 412. In step 412, an AGP is generated based on the transmission power and the recorded RSSI measurements. The exemplary steps may proceed to the end step 413. In step 407, in instances when the pan steps are not done, the exemplary steps may proceed to step 405. In step 409, in instances when the tilt steps are not done, the exemplary steps may proceed to step 405. In step 411, in instances when the frequency steps are not done, the exemplary steps may proceed to step 405.

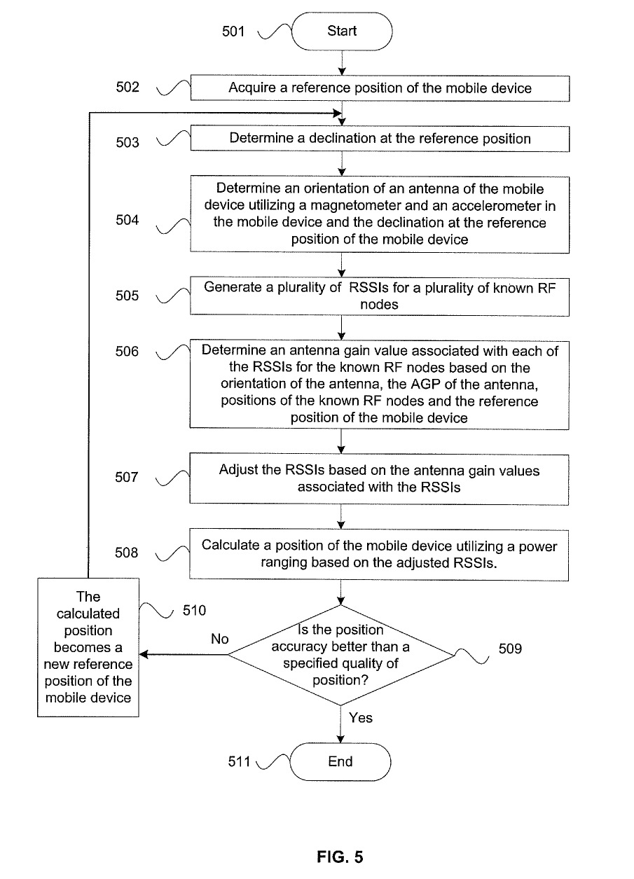

FIG. 5 is a flow chart illustrating exemplary steps for antenna orientation compensation for power ranging, in accordance with an embodiment of the invention. Referring to FIG. 5, the exemplary steps start at step 501. In step 502, the mobile device 200 may be operable to acquire a reference position of the mobile device 200. In step 503, the mobile device 200 may be operable to determine a declination at the reference position. In step 504, the mobile device 200 may be operable to determine an orientation of an antenna 202 of the mobile device 200 utilizing a magnetometer 204 and an accelerometer 204 in the mobile device 200 and the declination at the reference position of the mobile device 200. In step 505, the mobile device 200 may be operable to generate a plurality of RSSIs for a plurality of known RF nodes 310a, 310b, 310c. In step 506, the mobile device 200 may be operable to determine an antenna gain value associated with each of the RSSIs for the known RF nodes 310a, 310b, 310c based on the orientation of the antenna 202, the AGP of the antenna 202, positions of the known RF nodes 310a, 310b, 310c and the reference position of the mobile device 200. In step 507, the mobile device 200 may be operable to adjust the RSSIs based on the antenna gain values associated with the RSSIs. In step 508, the mobile device 200 may be operable to calculate a position of the mobile 200 utilizing a power ranging such as, for example, iterating a non-linear estimation based on the adjusted RSSIs. In step 509, the position accuracy is checked. In instances when the position accuracy is better than a specified quality of position, the exemplary steps may proceed to the end step 511. In step 509, in instances when the position accuracy is not better than a specified quality of position, the exemplary steps may proceed to step 510. In step 510, the calculated position becomes a new reference position of the mobile device 200 and the exemplary steps may proceed to step 503.

In various embodiments of the invention, a mobile device 200 comprising an antenna 202 may be operable to adjust a plurality of RSSIs for a plurality of known RF nodes 310a, 310b, 310c based on an orientation of the antenna 202 and an AGP of the antenna 202. The mobile device 200 may be operable to calculate a position of the mobile device 200 utilizing a power ranging based on the adjusted plurality of RSSIs. In this regard, the mobile device 200 may be operable to acquire a reference position of the mobile device 200 and calculate the position of the mobile device by iterating a non-linear estimation based on the reference position of the mobile device 200 and the adjusted plurality of RSSIs. The mobile device 200 may be operable to generate an AOR utilizing a magnetometer 204 in the mobile device 200, an accelerometer 206 in the mobile device 200 and a declination at the reference position. The mobile device 200 may be operable to determine the orientation of the antenna 202 based on the antenna orientation report. The mobile device 200 may be operable to determine an antenna gain value associated with each of the plurality of RSSIs for the plurality of known RF nodes 310a, 310b, 310c based on the orientation of the antenna 202, the AGP of the antenna 202, positions of the known RF nodes 310a, 310b, 310c and the reference position of the mobile device 200. In instances where the antenna gain value associated with a RSSI indicates a signal loss, the mobile device 200 may be operable to increase the value of the RSSI according to the antenna gain value. In instances where the antenna gain value associated with a RSSI indicates a signal gain, the mobile device 200 may be operable to decrease the value of the RSSI according to the antenna gain value. The mobile device 200 may be operable to acquire the AGP of the antenna 202 from either a location server 120 or from information stored in the mobile device 200.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for antenna orientation compensation for power ranging.

Accordingly, the present invention may be realized in hardware, software, or a combination of hardware and software. The present invention may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for communication, the method comprising:
performing by one or more processors and/or circuits in a mobile device comprising an antenna:
adjusting a plurality of received signal strength indications (RSSIs) for a plurality of known RF nodes based on an orientation of said antenna and an antenna gain profile (AGP) of said antenna; and
calculating a position of said mobile device utilizing a power ranging based on said adjusted plurality of RSSIs.

2. The method according to claim 1, comprising acquiring a reference position of said mobile device.

3. The method according to claim 2, comprising calculating a position of said mobile device by iterating a non-linear estimation based on said acquired reference position of said mobile device and said adjusted plurality of RSSIs.

4. The method according to claim 2, comprising determining a declination at said reference position of said mobile device.

5. The method according to claim 4, comprising:
generating an antenna orientation report (AOR) utilizing a magnetometer in said mobile device, an accelerometer in said mobile device and said declination at said reference position; and
determining said orientation of said antenna based on said antenna orientation report.

6. The method according to claim 5, comprising determining an antenna gain value associated with each of said plurality of RSSIs for said plurality of known RF nodes based on said orientation of said antenna, said AGP of said antenna, positions of said plurality of known RF nodes and said reference position of said mobile device.

7. The method according to claim 6, comprising increasing a value of one of said plurality of RSSIs according to said antenna gain value associated with said one of said plurality of RSSIs when said antenna gain value associated with said one of said plurality of RSSIs indicates a signal loss.

8. The method according to claim 6, comprising decreasing a value of one of said plurality of RSSIs according to said antenna gain value associated with said one of said plurality of RSSIs when said antenna gain value associated with said one of said plurality of RSSIs indicates a signal gain.

9. The method according to claim 1, comprising acquiring said AGP of said antenna from a location server.

10. The method according to claim 1, comprising acquiring said AGP of said antenna from information stored in said mobile device.

11. A system for communication, the system comprising:
one or more processors and/or circuits for use in a mobile device comprising an antenna, wherein said one or more processors and/or circuits are operable to:
adjust a plurality of received signal strength indications (RSSIs) for a plurality of known RF nodes based on an orientation of said antenna and an antenna gain profile (AGP) of said antenna; and
calculate a position of said mobile device utilizing a power ranging based on said adjusted plurality of RSSIs.

12. The system according to claim 11, wherein said one or more processors and/or circuits are operable to acquire a reference position of said mobile device.

13. The system according to claim 12, wherein said one or more processors and/or circuits are operable to calculate a position of said mobile device by iterating a non-linear estimation based on said acquired reference position of said mobile device and said adjusted plurality of RSSIs.

14. The system according to claim 12, wherein said one or more processors and/or circuits are operable to determine a declination at said reference position of said mobile device.

15. The system according to claim 14, wherein said one or more processors and/or circuits are operable to:
generate an antenna orientation report (AOR) utilizing a magnetometer in said mobile device, an accelerometer in said mobile device and said declination at said reference position; and
determine said orientation of said antenna based on said antenna orientation report.

16. The system according to claim 15, wherein said one or more processors and/or circuits are operable to determine an antenna gain value associated with each of said plurality of RSSIs for said plurality of known RF nodes based on said orientation of said antenna, said AGP of said antenna, positions of said plurality of known RF nodes and said reference position of said mobile device.

17. The system according to claim 16, wherein said one or more processors and/or circuits are operable to increase a value of one of said plurality of RSSIs according to said antenna gain value associated with said one of said plurality of RSSIs when said antenna gain value associated with said one of said plurality of RSSIs indicates a signal loss.

18. The system according to claim 16, wherein said one or more processors and/or circuits are operable to decrease a value of one of said plurality of RSSIs according to said antenna gain value associated with said one of said plurality of RSSIs when said antenna gain value associated with said one of said plurality of RSSIs indicates a signal gain.

19. The system according to claim 11, wherein said one or more processors and/or circuits are operable to acquire said AGP of said antenna from a location server.

20. The system according to claim 11, wherein said one or more processors and/or circuits are operable to acquire said AGP of said antenna from information stored in said mobile device.
